(19) United States
(12) Patent Application Publication
(10) Pub. No.: US 2008/0290848 A1
(43) Pub. Date: Nov. 27, 2008

(54) VOLTAGE REGULATOR WITH MANAGED GATE-DRIVE VOLTAGE

(76) Inventor: Don J. Nguyen, Portland, OR (US)

Correspondence Address: BUCKLEY, MASCHOFF & TALWALKAR LLC, 50 LOCUST AVENUE, NEW CANAAN, CT, 06840, US

(21) Appl. No.: 11/752,593

(22) Filed: May 23, 2007

(51) Int. Cl. G05F 1/10

(52) U.S. Cl. 323/282

(57) ABSTRACT

A system may include control of a voltage regulator to provide a regulated output voltage and output current to a load coupled to an output node of the voltage regulator, and changing of a gate-drive supply voltage provided to the voltage regulator based on the output current.

### BACKGROUND

A voltage regulator may convert power that is received from a power supply at first voltage and current levels to second voltage and current levels. FIG. 1 is a block diagram of conventional voltage regulator 1 used to receive unregulated battery voltage (typically 9-12.6V) at node V_{DC} and provide a regulated output voltage (typically 1V) at node V_{CORE} to power the core rail of CPU 10. Regulator 1 employs N-Channel MOSFETS 2 to switch the voltage at V_{DC} to the input side of inductor 3 periodically to cause current in inductor 3 to ramp up/down. Output capacitor 4 smooths the voltage provided at node V_{CORE}. To minimize self-heating of such a regulator, designers attempt to maximize the efficiency of the voltage/power conversion process.

Efficiency may be increased by selecting MOSFETS 2 to minimize both switching and conduction loss. Conduction loss mainly consists of the voltage/power drop across the drain-to-source channels' on-resistance (R_{DS-ON}), so selecting MOSFETS 2 having low R_{DS-ON} minimizes conduction loss. Unfortunately, lower R_{DS-ON} MOSFETS typically exhibit high parasitic capacitances composed of gate-to-source, drain-to-source and drain-to-gate capacitances. Such high parasitic capacitances result in high switching (transitional and gate-driving) loss.

### BRIEF DESCRIPTION OF THE DRAWINGS

FIG. 1 is a schematic diagram of a conventional voltage regulator.

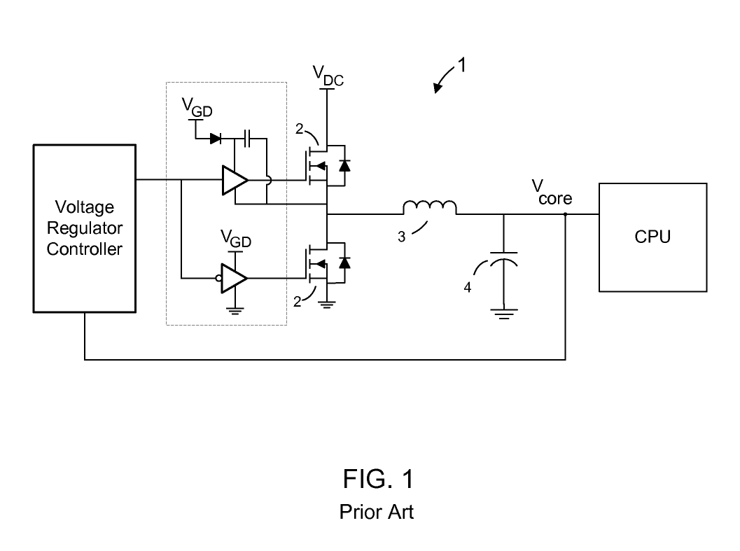

FIG. 2 is a schematic diagram of a voltage regulator according to some embodiments.

FIG. 3 is a diagram of a process according to some embodiments.

FIGS. 4A and 4B comprise schematic diagrams of two voltage regulators according to some embodiments.

### DETAILED DESCRIPTION

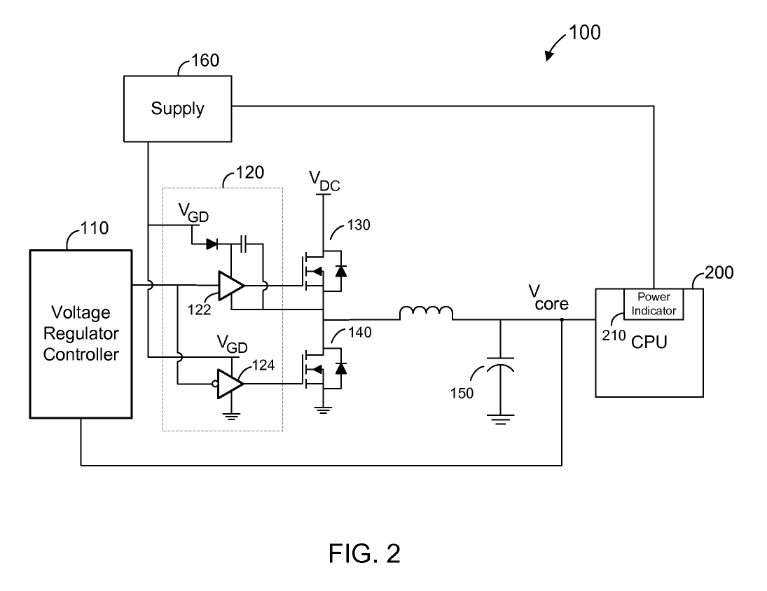

FIG. 2 is a schematic diagram of voltage regulator 100 according to some embodiments. Voltage regulator 100 may be used to convert a supply voltage at node V_{DC} to a desired output voltage at V_{CORE}. Voltage regulator 100 may be used in a computer motherboard or in any other platform according to some embodiments. For example, voltage regulator 100 may be implemented as a voltage regulator “module” that is mounted to a substrate that in turn may be coupled to a motherboard, as a voltage regulator “down” having elements that are mounted directly on a motherboard, or in any other fashion.

Voltage regulator 100 includes voltage regulator controller 110 and voltage regulator drivers 120. In one example of operation, voltage controller 110 transmits control signals to drivers 122 and 124, which are supplied by a gate-drive supply voltage at node V_{GD}. By virtue of the illustrated inversion, the control signal transmitted to driver 124 is 180 degrees out of phase with the control signal transmitted to driver 122. Drivers 122 and 124 control respective power switching elements 130 and 140 in accordance with the control signals.

Due to the phase relationship of the aforementioned control signals, one of elements 130 and 140 will be “closed” (i.e., substantially allowing current to pass from drain to source) and the other will be “open” (i.e., substantially preventing current from passing from drain to source) during operation. The selective opening and closing of elements 130 and 140 is intended to cause a desired voltage to develop at output node V_{CORE}. Under some circumstances, output capacitor 150 may discharge from output node V_{CORE} to ground through power switching element 140.

Supply 160 comprises a circuit to change the gate-drive supply voltage provided to node V_{GD} based on the output current at V_{CORE}. In this regard, gate-driving loss (i.e., power required from drivers 120 to drive the gates of power switching elements 130 and 140) will increase inversely with the R_{DS-ON} of power switching elements 130 and 140 due to their large gate capacitances. Moreover, increasing the gate-drive supply voltage will increase the gate-driving loss as defined by P_{GAT-DRVE}=CFV². The Gate-driving loss and its influence on the power-conversion efficiency of regulator 100 will depend on the actual output loading condition. Accordingly, the present inventor has discovered the benefit of changing the gate-drive supply voltage of a voltage regulator depending on the loading condition (e.g., the output current).

In some embodiments, supply 160 determines a value of the output current at V_{CORE}. Power indicator 200 of CPU 200 may comprise circuitry to indicate a power state (e.g., C4 through C0) to supply 160. Such a power state may be associated with a specific operating current known to supply 160. Supply 160 may therefore determine the output current based on the power state indicated by power indicator 200.

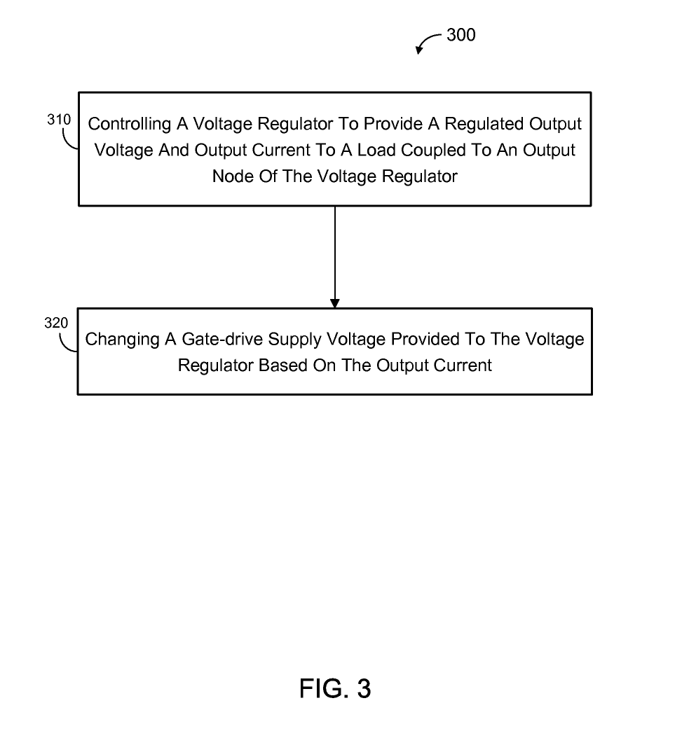

FIG. 3 is a flow diagram of process 300. Process 300 will be described in conjunction with previously-described elements of voltage regulator 100, but embodiments are not limited thereto. Process 300 may be executed by any suitable combination of discrete components, integrated circuits, and/or software.

Initially, at 310, a voltage regulator is controlled to provide a regulated output voltage and output current to a load coupled to an output node of the voltage regulator. In some embodiments of 310, voltage controller 110 transmits control signals to drivers 122 and 124, which in turn provide control signals to power switching elements 130 and 140. Elements 130 and 140 receive the control signals and cause a regulated voltage to develop at output node V_{CORE}. The regulated output voltage and associated output current are provided to a load (e.g., CPU 200) coupled to node V_{CORE}.

A gate-drive supply voltage provided to the voltage regulator is changed at 320 based on the output current. As mentioned above, supply 160 may change the gate-drive supply voltage provided to drivers 120 in some embodiments. As also mentioned above, supply 160 may determine a power state of the load (i.e., CPU 200) at 320 and change the gate-drive supply voltage based on the determined power state. Determination of the power state may comprise receiving an indication of the power state from power indicator 210.

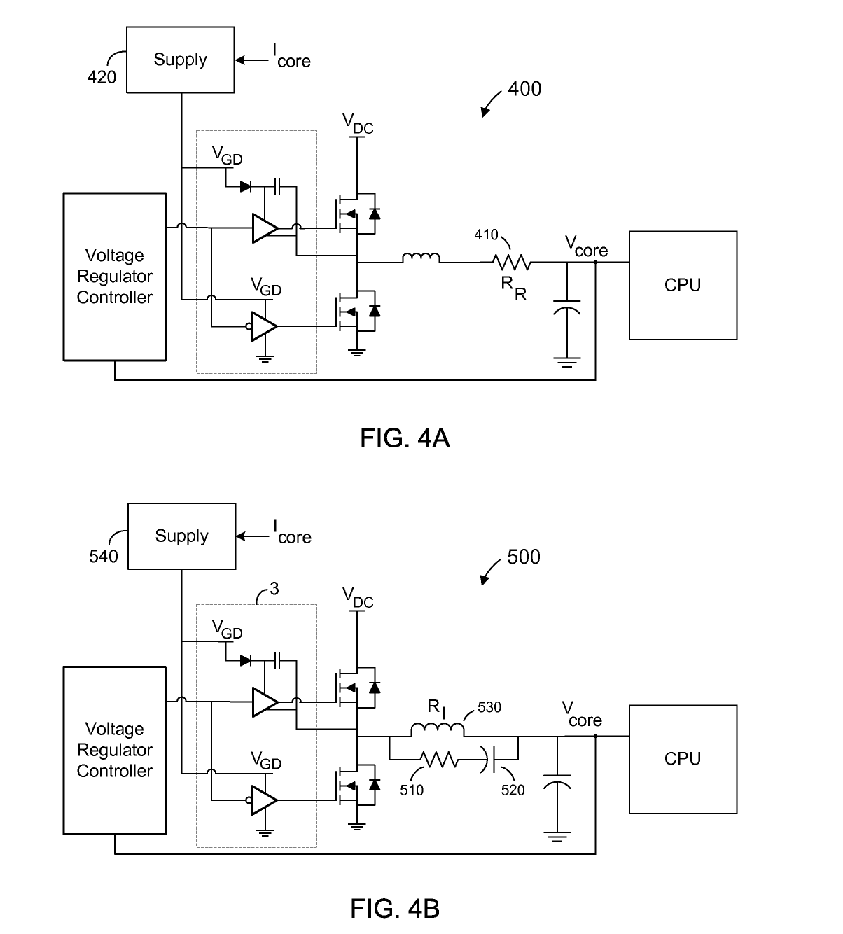

According to some embodiments, a value of the output current is determined and the gate-drive supply voltage is changed at 320 based on the determined value. Any system for determining the output current may be employed in such embodiments. FIGS. 4A and 4B illustrate two different systems for determining a value of the output current and changing the gate-drive supply voltage at 320 based on the determined value.

Voltage regulator 400 of FIG. 4A may be identical to voltage regulator 100 except for resistor 410 coupled in series to output node V_{CORE}. Known elements may be used to determine a voltage V_{R} across resistor 410 and to determine the output current based on the formula I_{CORE}=V_{R}/R_{R}. Supply 420 receives an indication of I_{CORE} and changes V_{GD} based thereon.

FIG. 4B is a schematic diagram of voltage regulator 500 according to some embodiments. Voltage regulator 500 includes resistor 510 and capacitor 520 coupled in parallel to inductor 530. Inductor 530, in turn, is coupled in series to output node V_{CORE}. A DC resistance R_{I} of inductor 530 is known from the specification of inductor 530, and a DC voltage V_{C} across capacitor 520 may be used to determine using known elements. The output current may therefore be determined based on the formula I_{CORE}=V_{C}/R_{I}. In some embodiments of 320, supply 540 receives an indication of the determined I_{CORE} and changes V_{GD} based thereon.

The several embodiments described herein are solely for the purpose of illustration. Some embodiments may include any currently or hereafter-known versions of the elements described herein. Therefore, persons in the art will recognize from this description that other embodiments may be practiced with various modifications and alterations.

What is claimed is:

1. A method comprising:
controlling a voltage regulator to provide a regulated output voltage and output current to a load coupled to an output node of the voltage regulator; and
changing a gate-drive supply voltage provided to the voltage regulator based on the output current.

2. A method according to claim 1, further comprising:
determining a value of the output current.

3. A method according to claim 2, wherein determining the value of the output current comprises:
determining a first voltage across a resistor coupled in series to the output node; and
determining the value of the output current based on the first voltage.

4. A method according to claim 2, wherein determining the value of the output current comprises:
determining a DC voltage across a capacitor coupled in parallel to the output node;
determining a DC resistance of an inductor coupled in series to the output node; and
determining the value of the output current based on the DC voltage and the DC resistance.

5. A method according to claim 1, further comprising:
determining a power state of the load.

6. A method according to claim 5, wherein the load comprises a microprocessor and wherein determining the power state comprises:
receiving an indication of the power state from the microprocessor.

7. An apparatus comprising:
a voltage regulator driver to receive a gate-drive supply voltage and to provide at least one control signal;
a voltage regulator power switching element to receive the at least one control signal and to provide a regulated output voltage and output current to an output node of the voltage regulator; and
a circuit to change the gate-drive supply voltage based on the output current.

8. An apparatus according to claim 7, wherein the circuit is to determine a value of the output current.

9. An apparatus according to claim 8, further comprising:
a resistor coupled in series to the output node,
wherein determination of the value of the output current comprises determination of a first voltage across the resistor, and determination of the value of the output current based on the first voltage.

10. An apparatus according to claim 8, further comprising:
a capacitor coupled in parallel to the output node; and
an inductor coupled in series to the output node,
wherein determination of the value of the output current comprises determination of a DC voltage across the capacitor, determination of a DC resistance of the inductor, and determination of the value of the output current based on the DC voltage and the DC resistance.

11. An apparatus according to claim 1, further comprising:
a load coupled to the output node,
wherein the circuit is to determine a power state of the load.

12. An apparatus according to claim 11, wherein the load comprises a microprocessor and wherein determination of the power state comprises reception of an indication of the power state from the microprocessor.
